(19) United States
(12) Patent Application Publication
(10) Pub. No.: US 2026/0219694 A1
(43) Pub. Date: Jul. 30, 2026

(54) MASS FLOW CONTROLLER HEALTH MONITORING SYSTEM

(71) Applicant: Applied Materials, Inc., Santa Clara, CA (US)

(72) Inventor: Ming Xu, San Jose, CA (US)

(21) Appl. No.: 19/354,289

(22) Filed: Oct. 9, 2025

Related U.S. Application Data
(60) Provisional application No. 63/751,372, filed on Jan. 30, 2025.

(51) Int. Cl. G05D 7/06; G01M 99/00

(52) U.S. Cl. CPC G05D 7/0635; G01M 99/005

(57) ABSTRACT

A method includes receiving a first group of parameters corresponding to a substrate manufacturing process, generating, using a statistical model, a first health index of a flow controller, receiving a second group of parameters corresponding to a flow controller used during the substrate manufacturing process, generating, using a physical model, a second health index of the flow controller, and based on at least one of the first and second health indices, perform a corrective action with respect to the flow controller.

### TECHNICAL FIELD

Some embodiments of the disclosure relate, in general, to systems and methods for monitoring the health of a flow controller, such as a mass flow controller (MFC) of a substrate processing system.

### BACKGROUND

Manufacturing of modern materials often involves various processing techniques, such as deposition (e.g., chemical vapor deposition (CVD) or physical vapor deposition (PVD)) techniques, etch techniques, etc. in which one or more atoms of one or more selected types are deposited on a substrate (wafer) or removed from the substrate held in low or high vacuum environments that are provided by vacuum deposition chambers. Materials manufactured in this manner may include monocrystals, semiconductor films, fine coatings, and numerous other substances used in practical applications, such as electronic device manufacturing. Many of these applications rely on the purity and uniformity of the materials grown in substrate processing systems as well as uniformity of the processes. The goal of uniformity gives rise to the monitoring and measuring the uniformity of substrates and manufacturing processes. Improving precision, reliability, and efficiency of such techniques presents a number of technological challenges.

### SUMMARY

In some embodiments of the present disclosure, a system includes one or more processing chambers. The system also includes one or more first sensors that each measure at least one of a first group of parameters of a substrate manufacturing process implemented using the one or more processing chambers. The system also includes a mass flow controller (MFC) that controls a flow of one or more gases into the processing chamber(s). The system also includes one or more second sensors that each measure at least one of a second group of parameters of the MFC during the substrate manufacturing process. The system also includes one or more processors. The system also includes memory includes instructions that, when executed by the one or more processors, cause the one or more processors to receive the first group of parameters, generate, using a statistical model, a first health index of the MFC, receive the second group of parameters, generate, using a physical model, a second health index of the MFC, and based on at least one of the first and second health indices, perform a corrective action with respect to the MFC.

In some embodiments of the present disclosure, a device includes one or more processors. The device also includes memory includes instructions that, when executed by the one or more processors, cause the one or more processors to receive a first group of parameters corresponding to a substrate manufacturing process, generate, using a statistical model, a first health index of the MFC, receive a second group of parameters corresponding to a mass flow controller (MFC) used during the substrate manufacturing process, generate, using a physical model, a second health index of the MFC, and based on at least one of the first and second health indices, perform a corrective action with respect to the MFC.

In some embodiments of the present disclosure, a method includes receiving a first group of parameters corresponding to a substrate manufacturing process, generating, using a statistical model, a first health index of the MFC, receiving a second group of parameters corresponding to a mass flow controller (MFC) used during the substrate manufacturing process, generating, using a physical model, a second health index of the MFC, and based on at least one of the first and second health indices, perform a corrective action with respect to the MFC.

### BRIEF DESCRIPTION OF THE DRAWINGS

The disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

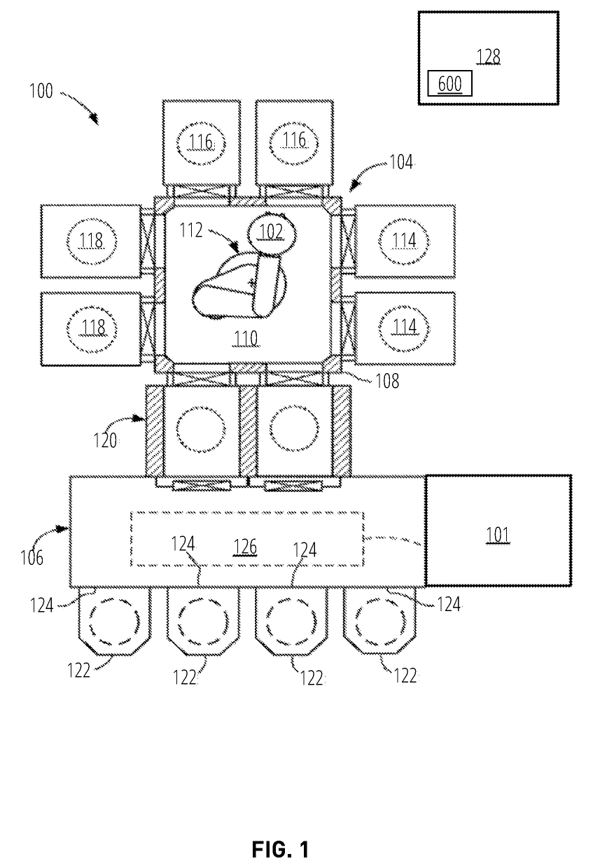

FIG. 1 is a top schematic view of an example processing system, according to one embodiment.

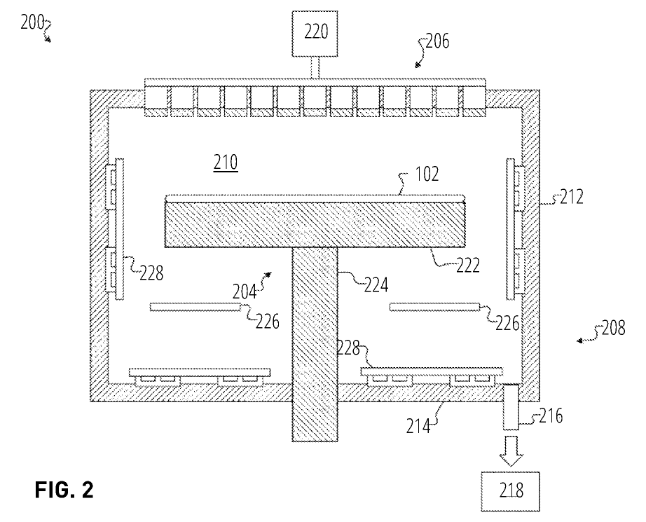

FIG. 2 depicts a sectional view of a manufacturing chamber according to certain embodiments.

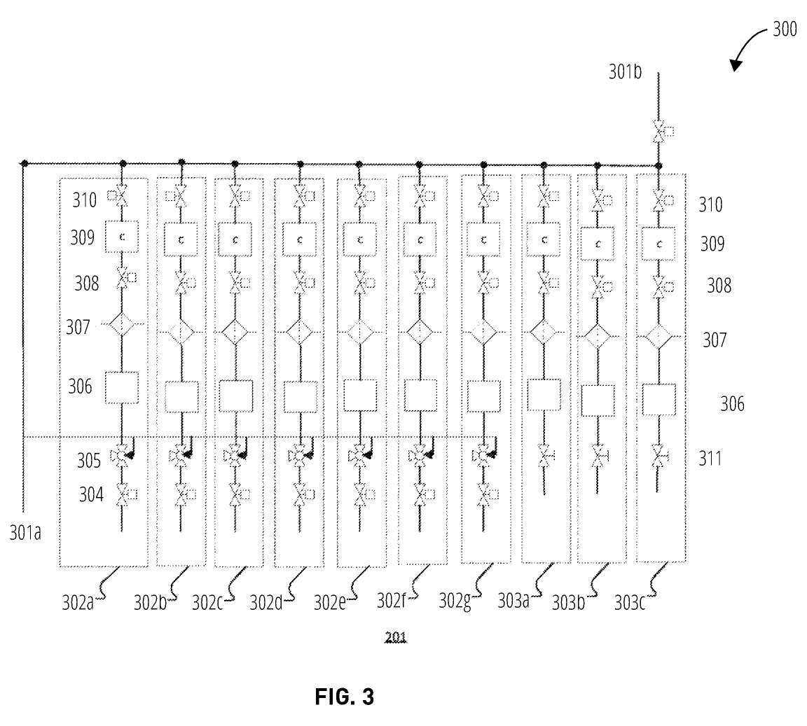

FIG. 3 illustrates a schematic of a gas panel of the manufacturing chamber according to an embodiment of the present disclosure.

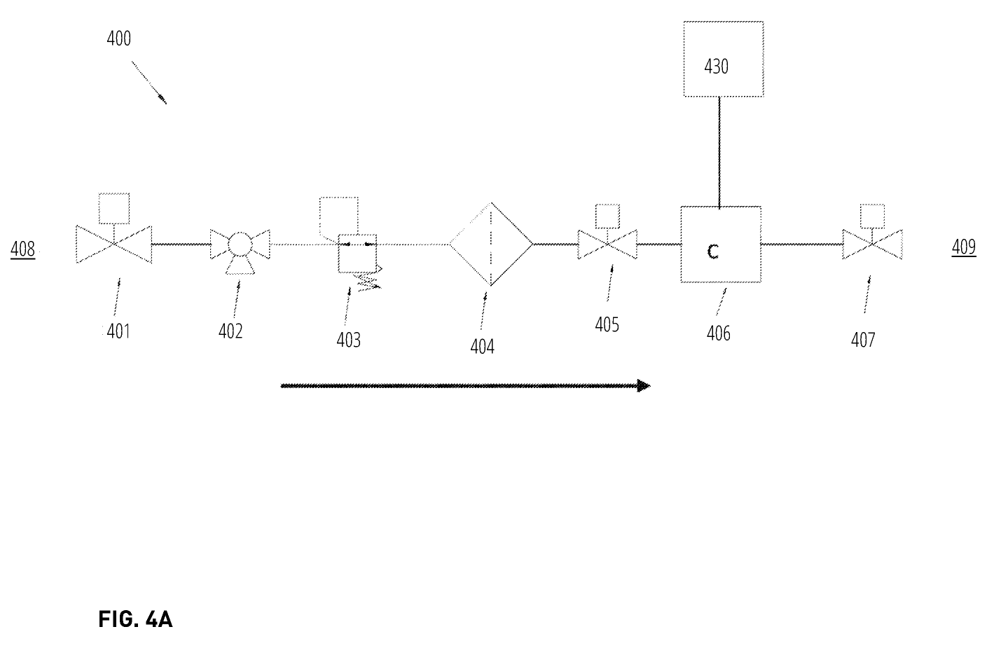

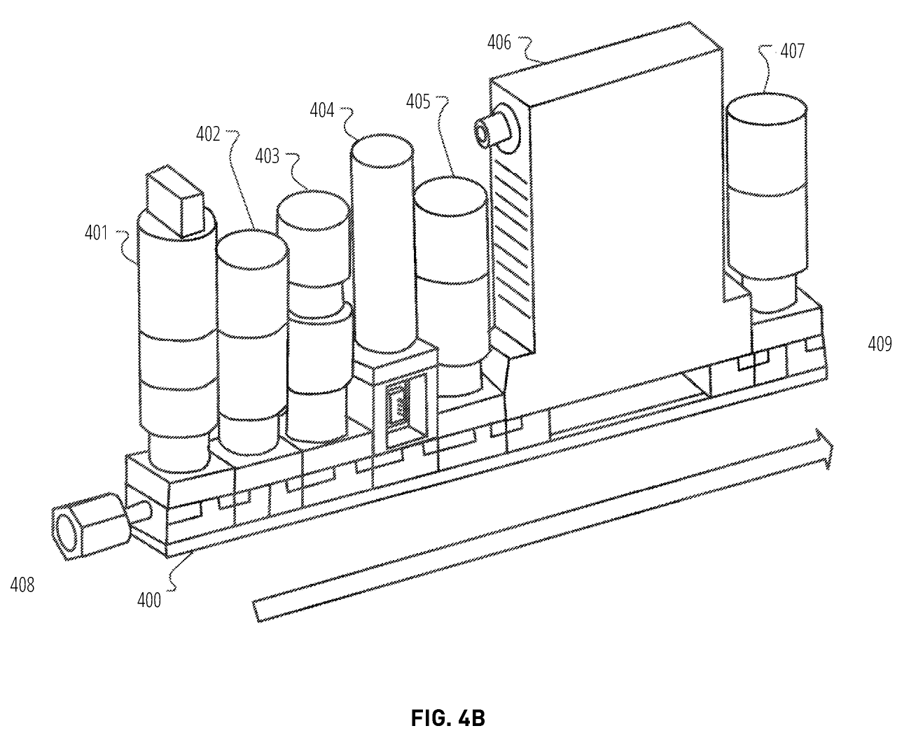

FIG. 4A illustrates a schematic of a gas stick assembly for use in the gas panel according to an embodiment of the present disclosure.

FIG. 4B illustrates a gas stick assembly for use in the gas panel according to an embodiment of the present disclosure.

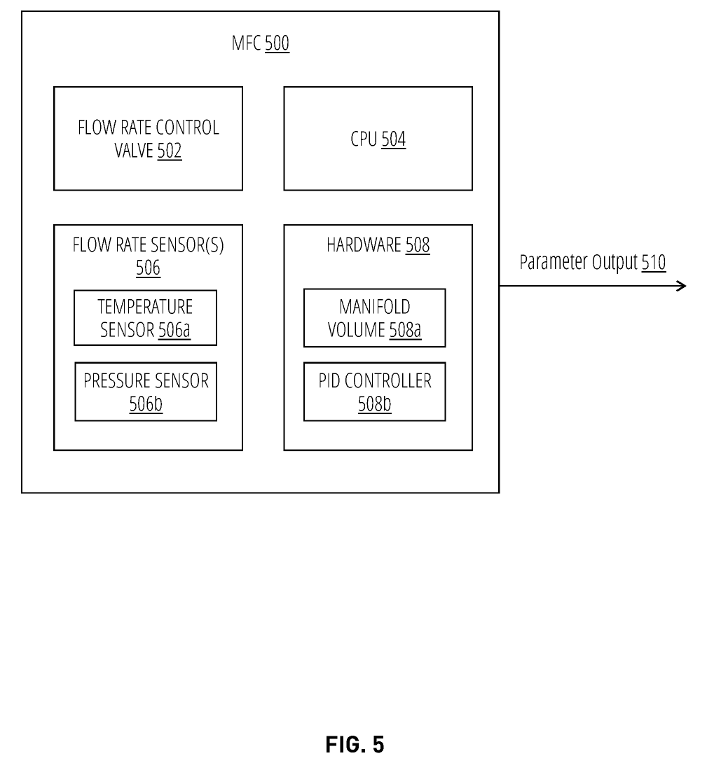

FIG. 5 is a block diagram illustrating various components of a mass flow controller (MFC), according to one embodiment.

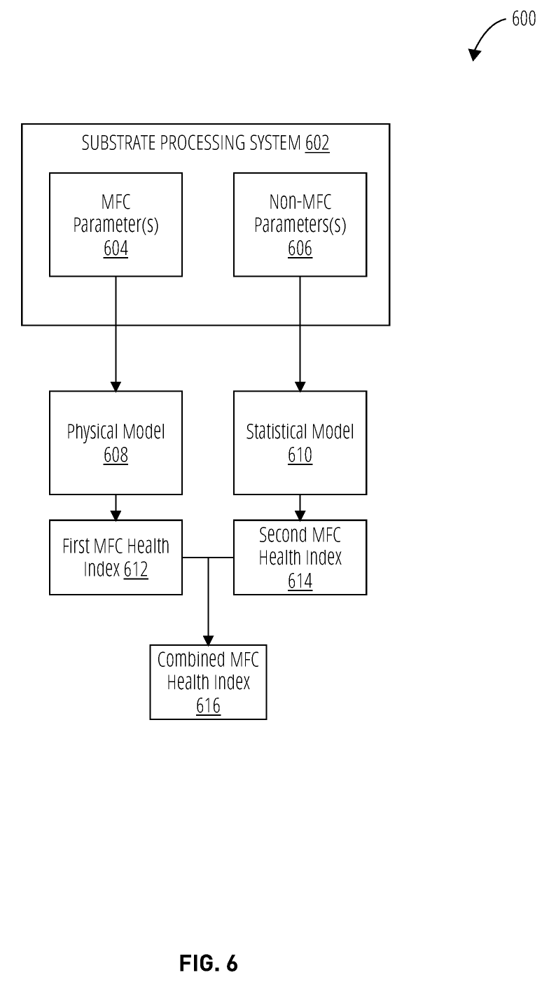

FIG. 6 is a flowchart illustrating a method of determining the health of an MFC, according to one embodiment.

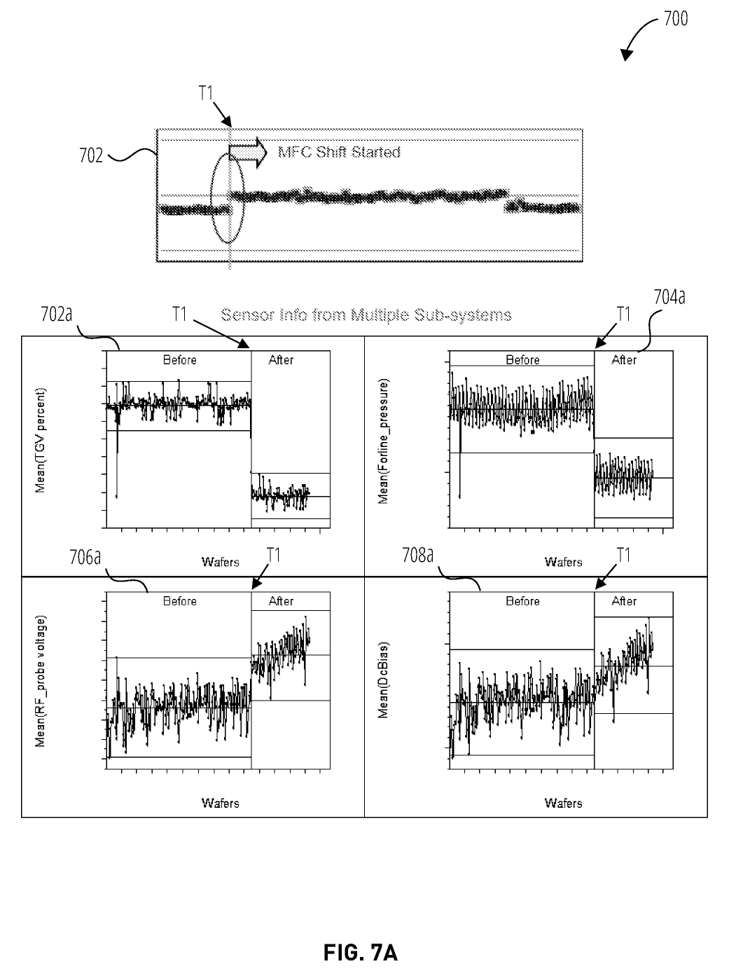

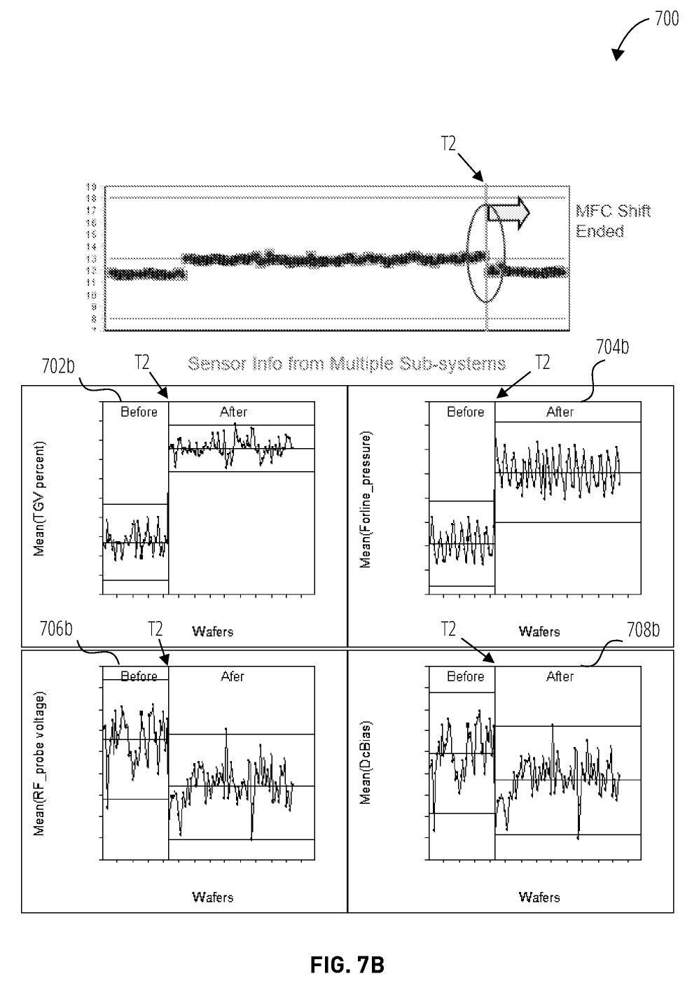

FIG. 7A and FIG. 7B illustrate exemplary graphs of different measured non-MFC parameters of a substrate processing system over time.

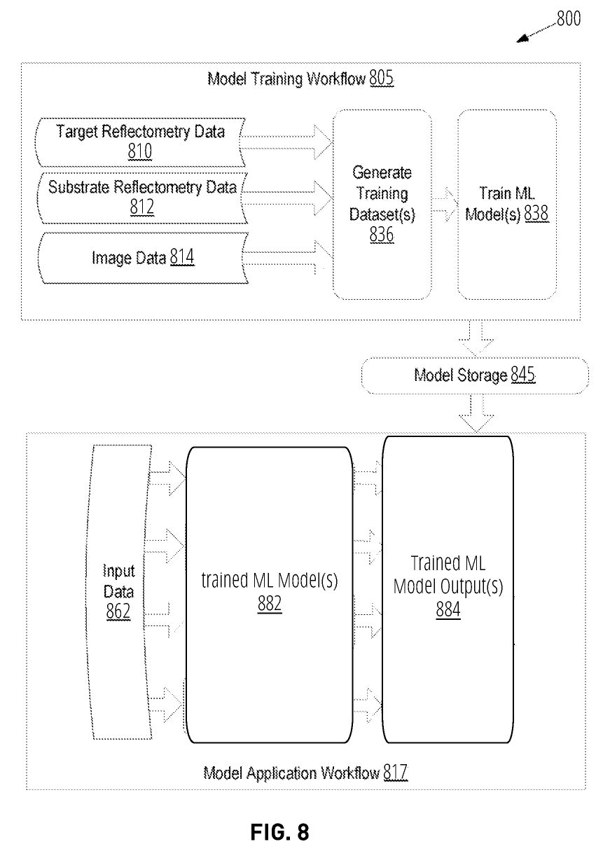

FIG. 8 illustrates a model training workflow and a model application workflow 817 for a process drift determination and a film thickness determination according to one embodiment.

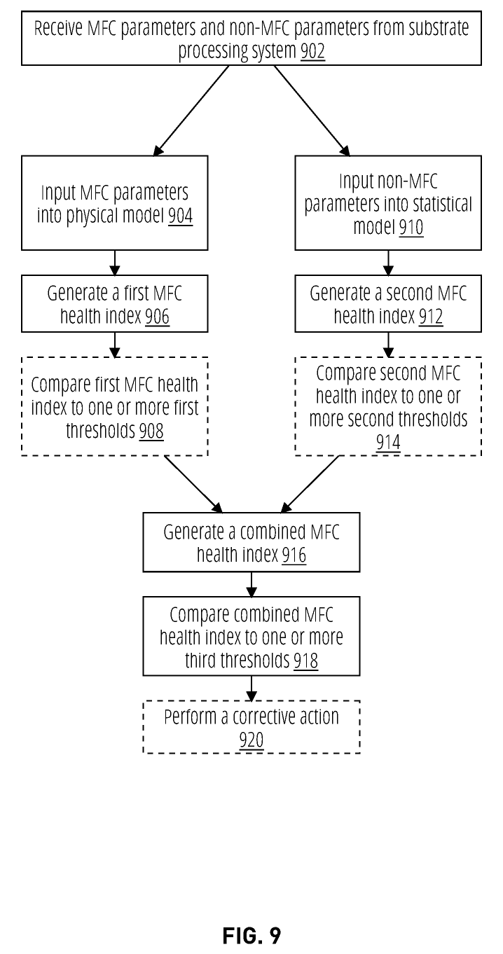

FIG. 9 is a flowchart illustrating a method of determining the health of an MFC, according to one embodiment.

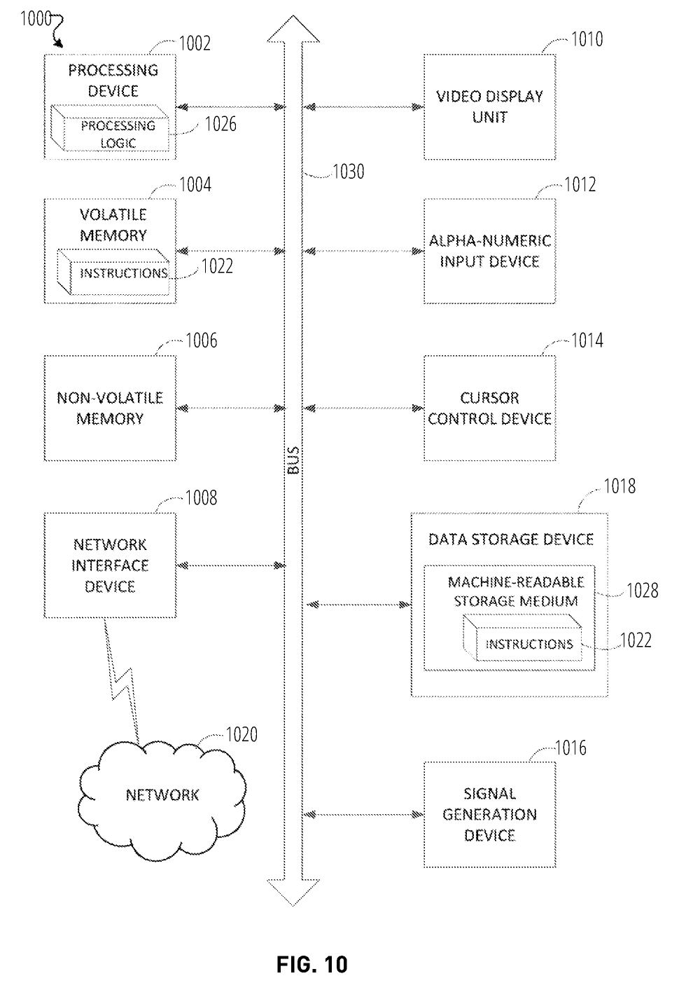

FIG. 10 depicts a block diagram of an example computing device capable of process drift and film thickness determination, operating in accordance with one or more aspects of the disclosure.

### DETAILED DESCRIPTION

Conventional approaches to monitoring MFC flow rates typically rely on built-in sensors to verify performance and MFC health. While these approaches may detect some malfunctions and deviations from target flow rates, they can fail to capture others. For example, sensor drift, partial obstructions, or gradual wear in internal MFC components may go undetected if the built-in sensors continue to report readings within nominal ranges. That is to say that, in at least some cases, conventional approaches to monitoring MFC health fail to determine that the MFC is actually in poor health due to all readily available MFC parameter data indicating otherwise. Such undetected faults can lead to compromised process quality, reduced yield, or unexpected downtime in industrial settings.

To address these shortcomings, Mass Flow Verifiers (MFVs) or Statistical Process Control (SPC) may be implemented. However, each of these techniques has notable limitations. MFVs, which measure the actual gas flow to confirm that the MFC’s reported flow matches its set point, can be time-consuming and disruptive. Often, lines are shut down or diverted, making frequent verification checks impractical and leaving long intervals in which performance degradation may go unnoticed. SPC, on the other hand, typically tracks a single variable (such as flow rate or pressure) over time. This single-variable focus can produce frequent false alarms under normal fluctuations while still overlooking complex, subtle interactions that signal early deterioration. As a result, both MFV and SPC can fail to provide a comprehensive, continuous, and reliable picture of MFC health.

Aspects and embodiments of the present disclosure provide a solution to the problems described above and others by providing systems and methods of determining MFC health based on MFC parameters and non-MFC parameters. According to embodiments, some non-MFC parameters of a substrate manufacturing process can be indicative of the MFC operating outside of normal parameter ranges. Other non-MFC parameters such as a throttle gate valve (TGV) position, a foreline pressure, a direct current (DC) bias, or a radio frequency (RF) probe voltage may experience a significant shift when the MFC malfunctions.

Aspects and embodiments of the present disclosure provide a first model (e.g., a physical model) of the MFC and a second model (e.g., a statistical model, machine learning model, etc.) of the non-MFC parameters. Measured or otherwise determined MFC parameters may be inputted into the first model. The output(s) of the physical model may be indicative of the health of the MFC. In at least one embodiment, MFC parameters (e.g., sensor readings) such as pressure, temperature, control valve position/voltage, and MFC hardware design parameters may be used within the first model to calculate a current flow rate, and the current flow rate may be compared to a flow rate setpoint or MFC reported flow. This comparison may be used to generate or otherwise determine a first MFC health index, which is indicative of the health of the MFC.

Measured or otherwise determined non-MFC parameters may be inputted into the second model. The output(s) of the second model may also be indicative of the health of the MFC. In at least one embodiment, non-MFC parameters (e.g., sensor readings) from different subsystems or modules such as an RF power module, a process module (i.e., processing chamber or foreline pressure), etc. may be used to build a multivariate statistical model, such as a multivariate regression model. In at least some cases, such a statistical model may be referred to as a virtual sensor. In another embodiment, these non-MFC parameters may be used to build an artificial intelligence (AI) model. Output(s) of the statistical model may be used to generate or otherwise determine a second MFC health index, which is also indicative of the health of the MFC. The first and second MFC health indices may be used individually or together for cross-checking.

In at least some embodiments, the group of parameters inputted into the first (e.g., physical) model and the group of parameters inputted into the second (e.g., statistical) model are mutually exclusive. For example, the physical model may be configured to analyze parameters outputted by the MFC or sensors corresponding to the MFC (MFC parameters), while the statistical model may be configured to analyze parameters outputted by components or sensors that do not directly implicate the condition of the MFC. Here the respective groups are mutually exclusive.

Aspects and embodiments of the present disclosure provide systems and methods to provide early detection and detection of gas delivery issues, which helps prevent on-wafer performance degradation and wafer scraping. By detection problems with gas delivery faster, aspects and embodiments of the present disclosure prevent excessive waste and improve substrate production efficiency.

Embodiments are described with reference to mass flow controller (MFCs). However, it should be understood that MFCs are just one type of flow controller that may be used, and that the embodiments described with reference to MFCs also apply to any other type of flow controller. Some examples of other types of flow controllers that may be used in embodiments include flow ratio controllers, back pressure controllers, and so on.

FIG. 1 is a top schematic view of an example processing system 100, according to one embodiment. In some embodiments, processing system 100 may be an electronics processing system configured to perform one or more processes on a substrate 102. In some embodiments, processing system 100 may be an electronics device manufacturing system. Substrate 102 can be any suitably rigid, fixed-dimension, planar article, such as, e.g., a silicon-containing disc or wafer, a patterned wafer, a glass plate, or the like, suitable for fabricating electronic devices or circuit components thereon.

Processing system 100 includes a process tool 104 (e.g., a mainframe) and a factory interface 106 coupled to process tool 104. Process tool 104 includes a housing 108 having a transfer chamber 110 therein. Transfer chamber 110 includes one or more processing chambers (also referred to as process chambers) 114, 116, 118 disposed therearound and coupled thereto. Processing chambers 114, 116, 118 can be coupled to transfer chamber 110 through respective ports, such as slit valves or the like.

Processing chambers 114, 116, 118 can be adapted to carry out any number of processes on substrates 102. A same or different substrate process can take place in each processing chamber 114, 116, 118. Examples of substrate processes include atomic layer deposition (ALD), physical vapor deposition (PVD), chemical vapor deposition (CVD), etching, annealing, curing, pre-cleaning, metal or metal oxide removal, or the like. In one example, a PVD process is performed in one or both of process chambers 114, an etching process is performed in one or both of process chambers 116, and an annealing process is performed in one or both of process chambers 118. Other processes can be carried out on substrates therein. Processing chambers 114, 116, 118 can each include a substrate support assembly. The substrate support assembly can be configured to hold a substrate in place while a substrate process is performed.

According to embodiments, processing chambers 114, 116, and 118 are supplied with process gases through one or more gas lines, which serve as conduits for delivering gas mixtures used during substrate processing processes such as chemical vapor deposition, atomic layer deposition, etching, or the like. Each gas line may include a gas stick, an integrated assembly designed to regulate and control gas flow with high precision. Each gas stick may include a mass flow controller (MFC), which monitors and controls gas flow into the respective processing chambers. The MFC may operate by continuously measuring gas flow rates using an integrated flow sensor and regulating the flow based on predefined setpoints. The MFC may also compensate for variations in pressure and temperature to maintain uniform gas delivery.

Transfer chamber 110 also includes a transfer chamber robot 112. Transfer chamber robot 112 can include one or multiple arms, where each arm includes one or more end effectors at the end of the arm. The end effector can be configured to handle particular objects, such as wafers. In some embodiments, transfer chamber robot 112 is a selective compliance assembly robot arm (SCARA) robot, such as a 2 link SCARA robot, a 3 link SCARA robot, a 4 link SCARA robot, and so on.

A load lock 120 can also be coupled to housing 108 and transfer chamber 110. Load lock 120 can be configured to interface with, and be coupled to, transfer chamber 110 on one side and factory interface 106 on another side. Load lock 120 can have an environmentally-controlled atmosphere that is changed from a vacuum environment (where substrates are transferred to and from transfer chamber 110) to at or near an atmospheric-pressure inert-gas environment (where substrates are transferred to and from factory interface 106) in some embodiments. In some embodiments, load lock 120 is a stacked load lock having a pair of upper interior chambers and a pair of lower interior chambers that are located at different vertical levels (e.g., one above another). In some embodiments, the pair of upper interior chambers are configured to receive processed substrates from transfer chamber 110 for removal from process tool 104, while the pair of lower interior chambers are configured to receive substrates from factory interface 106 for processing in process tool 104. In some embodiments, load lock 120 are configured to perform a substrate process (e.g., an etch or a pre-clean) on one or more substrates 102 received therein.

Factory interface 106 can be any suitable enclosure, such as, e.g., an Equipment Front End Module (EFEM). Factory interface 106 can be configured to receive substrates 102 from substrate carriers 122 (e.g., Front Opening Unified Pods (FOUPs)) docked at various load ports 124 of factory interface 106. A factory interface robot 126 (shown dotted) can be configured to transfer substrates 102 between substrate carriers 122 (also referred to as containers) and load lock 120. In other and/or similar embodiments, factory interface 106 is configured to receive replacement parts from replacement parts storage containers 123. Factory interface robot 126 can include one or more robot arms and can be or include a SCARA robot. In some embodiments, factory interface robot 126 has more links and/or more degrees of freedom than transfer chamber robot 112. Factory interface robot 126 can include an end effector on an end of each robot arm. The end effector can be configured to pick up and handle specific objects, such as wafers. Alternatively, or additionally, the end effector can be configured to handle objects such as process kit rings.

Any conventional robot type can be used for factory interface robot 126. Transfers can be carried out in any order or direction. Factory interface 106 can be maintained in, e.g., a slightly positive-pressure non-reactive gas environment (using, e.g., nitrogen as the non-reactive gas) in some embodiments.

Processing system 100 can include an integrated measurement and/or imaging system 101, which may be, for example, a reflectometry (IR) system. Reflectometry is a measurement technique that uses measured changes in light reflected from an object to determine geometric and/or material properties of the object. Reflectance spectrometers measure the intensity of reflected light across a range of wavelengths. For dielectric films these intensity variations may be used to determine the thickness of the film. Additionally, reflectometry measurements may be used to detect CD, CD-bias, and other physical parameters related to a substrate processing outcome.

Measurement and/or imaging system 101 may be connected to factory interface 106. Alternatively, measurement and/or imaging system 101 may be connected to transfer chamber (e.g., at a location of one of the illustrated processing chambers). Alternatively, the measurement and/or imaging system 101 may be positioned in an interior of the factory interface 106 or transfer chamber 110. Measurement and/or imaging system 101 may also be a standalone system that is not connected to processing system 100. Measurement and/or imaging system 101 may be mechanically isolated from factory interface 106 and from an external environment to protect measurement and/or imaging system 101 from external vibrations. In some embodiments, measurement and/or imaging system 101 and its contained components may provide analytical measurements (e.g., thickness measurements) that may provide a profile across a surface of a substrate, such as a thickness uniformity profile, a particle count profile, a CD profile, a CD uniformity profile, an optical constant profile, a material property profile, and so on. Measurement and/or imaging system 101 may provide feedback to a user regarding the uniformity profile. Measurement and/or imaging system 101 may be an assembly that has the ability to measure film thicknesses, CD, CD-bias, optical properties, particle count, material properties, surface roughness, etc. across the entire substrate after it is processed in a chamber. Such metrology may be used to monitor process drift, out-of-specification film thickness, out-of-specification CD, CD-bias, etc. for etch, deposition, and/or other processes. The results of the measurement may be used to quickly correct or adjust process parameters of one or more process recipes executed on one or more process chambers to account for any determined process drift. Additionally, the results of the measurements may be used to determine when to perform maintenance on a process chamber, when to perform further testing on a substrate, when to flag a substrate as being out-of-specification, and so on. Although depicted as being connected to factory interface 106, in other embodiments, measurement and/or imaging system 101 may be a standalone reflectometry system or may be positioned at another location in or attached to processing system 100, as described above.

Factory interface robot 126 may place a substrate on a substrate transfer lift (e.g., lift pins) of measurement and/or imaging system 101. In one embodiment, the substrate transfer lift may then lower the substrate onto a substrate support such as a chuck (e.g., a vacuum chuck or electrostatic chuck) of measurement and/or imaging system 101. In other embodiments, the substrate may instead be lowered onto another type of substrate holder, such as a mechanical chuck, a magnetic chuck, or the like. Measurement and/or imaging system 101 may include various covers and a ventilation system to maintain a clean substrate and environment.

Within measurement and/or imaging system 101, the substrate holder may be translated by a linear actuator so that an edge of the substrate is centered under an optical camera. The substrate and the substrate holder may then be rotated by a rotation motor (actuator) and an optical camera or first sensor (e.g., an IR sensor, visible light sensor, etc.) may capture images or measurements of the edge of the substrate. Motion of the substrate holder about a rotational axis may be referred to as theta motion, motion of the substrate holder along a linear axis may be referred to as r motion, and combined motion of the substrate holder about the rotational axis and along the linear axis may be referred to as r-theta motion herein. As will be described in further detail below, the images or measurements may be analyzed to determine a center point of the substrate. Moving the substrate holder with both a linear (e.g., radial) and rotational motion allows the total size of measurement and/or imaging system 101 to be minimized while still enabling the capturing of measurements along the entire surface of the substrate. For example, the measurement and/or imaging system 101 may have a width of about 16″-17″, a length of about 23″-24″, and a height of about 25″-26″ in an embodiment. In some embodiments, an measurement and/or imaging system 101 can be implemented with two linear actuators and no rotational actuator (where motion for such as a system is referred to as X-Y motion), however, this may lead to the measurement and/or imaging system having a larger footprint than measurement and/or imaging system 101. In some embodiments, measurement and/or imaging system 101 may have the capability to measure film thicknesses, CD, CD-bias, etc. of up to about 100 substrates or more per hour, which is a substantial increase in throughput as compared to traditional optical metrology systems that measure a full surface of a substrate. For each substrate, hundreds to thousands (e.g., 3000) points on each substrate may be measured. The measurements may be used to determine uniformity profiles of the substrates. Accordingly, in embodiments measurement and/or imaging system 101 may be able to determine a uniformity profile of a substrate in a time duration between 20 seconds and 50 seconds.

A sensor (e.g., a reflectometer), e.g., a second sensor, of measurement and/or imaging system 101 may be used to make measurements of one or more target positions on the substrate as it is moved by the linear actuator and the rotational motor. The one or more target positions may be determined based on an algorithm or set of instructions that specifies the location of the target positions and the number of target positions to be measured. In some instances, the substrate may not be centered on the substrate holder. In such an instance, processing logic may determine coordinate transformations to transform between a coordinate system centered on the substrate holder and a coordinate system centered on the substrate. Appropriate transformations may be applied for each position to be measured on the substrate. Accordingly, as the substrate holder (and thus the substrate attached to the substrate holder) are rotated, the substrate holder (and thus the substrate) are also moved linearly according to the transformations so that the correct point on the substrate is measured.

During setup of measurement and/or imaging system 101, the linear actuator and the rotational motor may be calibrated to determine the location of the reflectometer in relation to the axes of motion of the linear actuator and/or the rotational motor. Additionally, the substrate holder may have an integrated reference target (or multiple integrated reference targets), which can be measured by the second sensor (e.g., reflectometer) and/or captured by the first sensor (e.g., camera) to obtain reference measurements/images. The integrated reference target(s) may be positioned on the substrate holder and/or on a stage that supports the substrate holder at a position that will not be covered by the substrate, and may rotate and/or otherwise change position as the substrate holder is rotated and/or moved. An integrated reference target may have a known thickness, which does not change over time.

In one embodiment, the measurement and/or imaging system includes multiple reference targets, which may be made of different materials. For example, one reference target may include bare silicon, and one reference target may include silicon with a silicon dioxide layer having a known thickness. The sensor may periodically measure the thickness of the integrated reference target and compare the measured thickness to the known thickness of the integrated reference target. If the measured thickness does not correspond to the known thickness of the target, then processing logic may determine that the sensor is generating inaccurate measurements. In some embodiments, a linear offset may be determined based on a determined difference between the measured thickness and the known thickness of the integrated reference target. Alternatively, a non-linear offset may be determined. The linear or non-linear offset may be applied to measurements in order to obtain accurate adjusted measurements of film thickness. In one embodiment, processing logic determines whether the difference between the measured thickness of the reference target and the known thickness of the reference target exceeds a difference threshold. If the difference is below the difference threshold, then an adjustment may be applied, as described above. If the difference is at or above the difference threshold, then the measurement and/or imaging system 101 may be scheduled for maintenance. Measurement and/or imaging system 101 may perform calibration of the second sensor (e.g., reflectometer) either between measurements, during measurements, or both to determine appropriate offsets to apply to measurements.

In one embodiment, the integrated reference target may cause spectral reflections on the second sensor (e.g., reflectometer) from when it scans across the reference target while setting the stage. Processing logic can determine where the second sensor is relative to the target based on the positions (e.g., (r, theta) coordinates) at which spectral reflections are captured. A similar process may be determined for the first sensor (e.g., the camera). This can provide two coordinate systems that are both referenced by the target. The relationship between the first sensor coordinate system and the second sensor coordinate system can therefore be figured out through the reference target.

When the substrate is lowered onto and secured to the substrate holder, the center of the substrate may be offset from the center of the substrate holder. A processing device of measurement and/or imaging system 101 may determine one or more coordinate transformations between the center of the substrate and the center of the substrate holder (the center of the substrate holder corresponds to the axis of rotation about which the substrate holder rotates), and apply the one or more coordinate transformations to correct the offset, as described in greater detail below.

Processing system 100 can also include a system controller 128. System controller 128 can be and/or include a computing device such as a personal computer, a server computer, a programmable logic controller (PLC), a microcontroller, and so on. System controller 128 can include one or more processing devices, which can be general-purpose processing devices such as a microprocessor, central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device can also be one or more special-purpose processing devices such as an application specific integrated circuit (ASIC), a field programmable gate array (FPGA), a digital signal processor (DSP), network processor, or the like. System controller 128 can include a data storage device (e.g., one or more disk drives and/or solid state drives), a main memory, a static memory, a network interface, and/or other components. System controller 128 can execute instructions to perform any one or more of the methodologies and/or embodiments described herein. The instructions can be stored on a computer readable storage medium, which can include the main memory, static memory, secondary storage and/or processing device (during execution of the instructions). In embodiments, execution of the instructions by system controller 128 causes system controller to perform the methods of 5. System controller 128 can also be configured to permit entry and display of data, operating commands, and the like by a human operator.

FIG. 2 depicts a sectional view of a manufacturing chamber 200 (e.g., a semiconductor processing chamber) according to some aspects of this disclosure. Manufacturing chamber 200 may be one or more of an etch chamber (e.g., a plasma etch chamber), deposition chamber (including atomic layer deposition, chemical vapor deposition, physical vapor deposition, or plasma enhanced versions thereof), anneal chamber, or the like. For example, manufacturing chamber 200 may be a chamber for a plasma etcher, a plasma cleaner, atomic layer deposition (ALD) device, chemical vapor deposition (CVD) device, and so forth. Examples of chamber components may include a substrate support assembly 204, an electrostatic chuck, a ring (e.g., a process kit ring), a chamber wall, a base, a showerhead 206, a gas distribution plate, a liner, a liner kit, a shield, a plasma screen, a flow equalizer, a cooling base, a chamber viewport, a chamber lid, a nozzle and so on.

In one embodiment, manufacturing chamber 200 may include a chamber body 208 and a showerhead 206 that enclose an interior volume 110. In some chambers, showerhead 206, may be replaced by a lid and a nozzle. Chamber body 208 may be constructed from aluminum, stainless steel, or other suitable material. Chamber body 208 generally includes sidewalls 212 and a bottom 214.

An exhaust port 216 may be defined in chamber body 208, and may couple interior volume 110 to a pump system 218. Pump system 218 may include one or more pumps and valves utilized to evacuate and regulate the pressure of interior volume 110 of manufacturing chamber 200. An actuator to control gas flow out of the chamber and/or pressure in the chamber may be disposed at or near exhaust port 216.

Showerhead 206 may be supported on sidewalls 212 of chamber body 208 or on a top portion of the chamber body. Showerhead 206 (or the lid, in some embodiments) may be opened to allow access to interior volume 110 of manufacturing chamber 200, and may provide a seal for manufacturing chamber 200 while closed.

Gas panel 220 may be coupled to manufacturing chamber 200 to provide process or cleaning gases to interior volume 110 through showerhead 206 (or lid and nozzle). The Gas panel 220 may be coupled to the manufacturing chamber 200 to provide process and/or cleaning gases via one or more supply line to the interior volume 110 through showerhead 206. The Gas panel 220 may include or be connected to one or more flow control apparatus. The flow control apparatus(es) may be used to measure and control the flow of one or more gasses from one or more gas sources to interior volume 110. In one embodiment, the Gas panel 220 includes multiple gas stick assemblies, as detailed below with reference to FIG. 3 to FIG. 4B. Each gas stick assembly may include one or more valves, filters, mass flow controllers (MFCs) and/or other components, as set forth below.

Showerhead 206 may include multiple gas delivery holes throughout. Examples of processing gases that may be used to process substrates in manufacturing chamber 200 may include toxic gases, non-toxic gases, or a combination thereof. For example, the processing gases may include halogen-containing gases, such as C₂F₆, SF₆, SiCl₄, HBr, NF₃, CF₄, CHF₃, F₂, Cl₂, CCl₄, BCl₃, and SiF₄, among others, and other gases such as O₂ or N₂O. Examples of carrier gases include N₂, He, Ar and other gases inert to process gases (e.g., non-reactive gases).

Substrate support assembly 204 may be disposed in interior volume 110 of manufacturing chamber 200 below showerhead 206. In some embodiments, substrate support assembly 204 includes a susceptor 222 and shaft 224. Substrate support assembly 204 supports a substrate during processing. In some embodiments, also disposed within manufacturing chamber 200 are one or more heaters 226 and reflectors 228.

In some embodiments, showerhead 206 is configured to produce plasma via RF discharge. Maximum power delivery depends on matching impedance between the RF source and the plasma. Impedance matching may be performed by a closed loop control system. Sensors measuring properties related to the RF impedance matching (RF match) may be monitored. Impedance within manufacturing chamber 200 is highly correlated with chamber pressure. Monitoring properties related to RF impedance matching (e.g., RF match voltage, RF match current, RF match capacitor position) may provide insight into the pressure inside the manufacturing chamber.

In at least some embodiments, the manufacturing chamber 200 may include a combination of modules, components, sensors, or the like that each can provide parameter information related to the processing of a substrate. For example, the manufacturing chamber 200 can include an RF power module that supplies radio frequency (RF) energy to the processing chamber. The RF power module may include a source RF generator that delivers RF power to the manufacturing chamber 200. The source RF generator may provide measurable parameters, including forward power, which represents the energy delivered toward the chamber, and reflected power, which corresponds to energy reflected back due to impedance mismatches. Additionally, the source RF generator may output temperature information, which can indicate thermal characteristics of the generator and/or transmission path.

In some embodiments, the RF power module can further include an RF probe positioned, in at least some cases, along the transmission path to measure electrical characteristics of the RF signal. The RF probe may be capable of providing voltage and current measurements corresponding to the RF signal at a particular location in the system. Additionally, the RF probe may determine phase information, which represents the phase angle between the voltage and current waveforms. This phase information can be used to assess impedance characteristics, power delivery efficiency, or resonance conditions within the processing system.

The RF power module can also include a matcher, which may be capable of dynamically adjusting impedance to optimize RF power transfer to the processing chamber. In at least one embodiment, the matcher can provide series/shunt configuration parameters, indicating the selected impedance matching topology. Additionally, the matcher may be capable of providing cap position information, representing the position of tunable capacitor elements used for impedance adjustments. Further, the matcher may be capable of providing cap current measurements, which indicate the current flowing through the capacitive elements.

In some embodiments, the manufacturing chamber 200 can further include a process module configured to provide information about pressure-related and temperature-related parameters within the manufacturing chamber 200. The process module may include various sensing and monitoring components that enable real-time assessment of chamber conditions. A pressure monitoring subsystem provides data related to vacuum and gas flow conditions within the processing chamber. A throttle gate valve (TGV), positioned along the exhaust path, may include position sensors capable of reporting the TGV open position, indicating the degree to which the valve is opened. Additionally, the system may incorporate one or more pressure gauges, such as capacitance manometers or piezoelectric pressure transducers, which provide pressure readings at different locations within the chamber. Further, the system may include throttle valve assemblies equipped with sensors or feedback mechanisms that provide throttle valve parameters, such as actuation status, sealing integrity, or detected leakage, which may be used to assess vacuum stability.

A temperature monitoring subsystem provides information about thermal conditions affecting the processing environment. A chiller unit, used to regulate coolant flow, may be equipped with sensors that provide chiller status parameters, including coolant temperature, flow rate, or pressure. In some cases, the temperature monitoring subsystem includes helium (He) cooling mechanisms, or alternative gas-based cooling, with pressure or flow sensors that provide cooling gas parameters relevant to thermal control. Additionally, temperature sensors such as thermocouples, resistance temperature detectors (RTDs), or infrared sensors may be placed at various locations within the chamber to provide temperature readings, offering insight into substrate temperature, chamber wall temperatures, or localized thermal conditions.

In some embodiments, one or more optical sensors may be used for endpoint detection. Such optical sensor(s) may measure a concentration of species remaining in the processing chamber. In embodiments, the optical sensor(s) measure a concentration of one or more species in a plasma in the processing chamber. Measurements from such optical sensors may be used for flow control health monitoring and/or chamber health monitoring in embodiments.

In various embodiments, the manufacturing chamber 200 can also include a chuck module that provide information related to electrical bias and temperature during substrate processing. The chuck module may incorporate various sensors or subsystems to monitor parameters associated with RF biasing, substrate thermal condition, and cooling gas behavior. For example, the manufacturing chamber 200 may include an electrical bias measurement subsystem that includes sensors for monitoring electrical bias parameters associated with the substrate or its surrounding structures. In some embodiments, voltage sensors are positioned within the chuck or electrical feedlines to provide voltage measurements, which indicate the RF or DC bias voltage applied to the substrate during processing. Similarly, current sensors may be integrated into the chuck’s electrical pathway to provide current measurements, enabling assessment of charge flow characteristics. Additionally, in implementations where a focus ring is present to assist in plasma confinement, the system may include dedicated sensors for measuring focus ring electrical parameters, such as floating potential or leakage current, to evaluate potential shifts in plasma uniformity.

A temperature monitoring subsystem of the chuck module may provide data related to substrate thermal management through temperature monitoring sensors. In some cases, the temperature monitoring subsystem of the chuck module may utilize helium (He) pressure sensors to provide He pressure measurements, which indicate the integrity of the gas layer used for thermal conduction between the substrate and the chuck surface. Additionally, He flow sensors may provide helium flow rate and leak rate information, offering insight into potential gas distribution issues or chuck sealing performance. Beyond helium-based cooling, the chuck module may support alternative cooling gases such as argon (Ar), nitrogen (N₂), or other inert gases, with corresponding pressure and flow sensors that provide data on gas delivery conditions. The system may further incorporate temperature sensors, such as thermocouples, RTDs, or infrared sensors, positioned within the chuck body or at gas flow interfaces to provide substrate temperature measurements and chuck surface temperature data, enabling real-time assessment of thermal conditions.

FIG. 3 is a schematic of a gas panel 300 that may be used in the manufacturing chamber of FIG. 2. As described above, the gas panel provides process and/or cleaning gases to the showerhead and/or to other components of a processing chamber. To effectively provide a process or cleaning gas, a gas stick assembly may be utilized.

The gas stick assembly of the present disclosure may be used with a toxic gas (e.g., as with gas stick assemblies 302a-g) or may be used with an inert or non-toxic gas (e.g., as with gas stick assemblies 303a-c). Each gas stick assembly 302a-g, 303a-c may be used to flow a different gas into the processing chamber in embodiments. To provide gas flow through the gas panel 300, a gas enters the panel through one end of the panel (e.g., input end 301a). For example, if a cleaning gas is used, it may enter the gas stick assembly where it flows through the appropriate gas stick assembly 302a-g, 303a-c and then flows into the processing chamber through an output end 301b. A purge gas may enter through the gas panel 300 through an input end 301a, in which it travels to the appropriate gas stick assembly 302a-g. The purge gas may be N₂ and may enter the gas stick assembly 302a-g through a purge valve 305 to remove any toxic gas before servicing the system.

The gas panel may include a single gas stick assembly 302a-g, multiple gas stick assemblies 302a-g, a single inert gas stick assembly 303a-c, and/or multiple inert gas stick assemblies 303a-c. For example, FIG. 3 depicts seven (7) gas stick assemblies 302a-g and three (3) inert gas stick assemblies 303a-c. However, this is not meant to limit the amount or type of gas stick assemblies that may be included in the gas panel 300. In some embodiments, the gas panel 300 may include 1, 2, 3, 4, 5, 6, 7, 8, 9, 10, 11, 12, 13, 14, 15, 16, 17, 18, 19, 20, or more (e.g., 40) gas stick assemblies 302a-g and 1, 2, 3, 4, 5, 6, 7, 8, 9, 10, 11, 12, 13, 14, 15, 16, 17, 18, 19, 20 or more (e.g., 40) inert gas stick assemblies 303a-c. Further, the components of each gas stick assembly 302a-g and inert gas stick assembly 303a-c of FIG. 3 are not labeled herein for clarity, but it is to be understood that each gas stick assembly 302a-g and inert gas stick assembly 303a-c may include the same or different components to those described herein for some gas stick assemblies. The gas stick assembly 302a-g in embodiments may include a hybrid valve 304, a purge valve 305, a regulator 306, a filter or purifier 307, an upstream valve 308, a mass flow controller 309 and a downstream valve 310. The hybrid valve 304 may allow for the gas to flow through the gas stick assembly if in an open position, or may keep gas from flowing into in the gas stick assembly if in a closed position. The hybrid valve 304 may include a combination of a manual valve and a valve that can be automatically actuated (e.g., a pneumatic valve, electrical valve, etc.). The purge valve 305 may be used to purge out toxic gas before working on the toxic gas stick assembly. The regulator 306 may be a pressure regulator which may control the pressure within the gas stick assembly 400. The filter or purifier 307 may reduce any contaminants from entering. The upstream valve 308 may be in an open or closed position to allow gas to either leave or remain in the mass flow controller 309, depending on the process. The mass flow controller 309 may include a pressure sensor, which provides pressure data of the gas stick assembly. The downstream valve 310 may be in an open or closed position to allow gas to either leave or remain in the mass flow controller 309, depending on the process. The inert gas stick assembly 303a-c in embodiments may include a manual valve 311, a regulator 306, a filter or purifier 307, an upstream valve 308, a mass flow controller 309 and a downstream valve 310.

FIG. 4A and FIG. 4B illustrate a gas stick assembly 400 according to an embodiment of the present disclosure. The gas stick assembly 400 is illustrative of the gas stick assembly 302a-g of FIG. 3. That is, gas stick assembly 400 represents a gas stick assembly that is used to flow toxic gases. For a gas stick assembly in which non-toxic gases flow, a purge valve 402 may not be present. As can be seen in FIG. 4A and FIG. 4B, the gas stick assembly 400 includes an input end 408 and an output end 409. A gas may flow through the gas stick assembly 400 from the input end 408 to the output end 409 as indicated by the arrow in FIG. 4A. The gas that flows through the gas stick assembly may be a gas as described in relation to the gas stick assemblies of FIG. 3. The gas stick assembly 400 may include a valve 401 that is upstream of a mass flow controller 406. A hybrid valve may include a combination of a manual valve and a valve that can be automatically actuated (e.g., a pneumatic valve, electrical valve, etc.).

If a toxic gas is to travel through the gas stick assembly, a purge valve 402 may be included, which may be used to purge out toxic gas before working on the toxic gas stick assembly. Next, a regulator 403 is included in the gas stick assembly 400. The regulator 403 may be a pressure regulator as known in the art. A filter 404 is also included upstream of the mass flow controller 406 in the gas stick assembly 400 to filter any contaminants from the gas. An isolation valve 405 is included upstream of the mass flow controller 406, and an isolation valve 407 is downstream of the mass flow controller 406 in the gas stick assembly 400. The isolation valve 407 is on the output end 409 of the gas stick assembly 400. The mass flow controller 406 of the present disclosure includes a pressure sensor, a controller (e.g., a processing device) and/or a variable or proportional valve that can control an amount of gas that flows through the mass flow controller based on instructions from the controller of the MFC. The MFC 406 is an instrument used to measure and control the flow of gasses. The MFC 406 may be designed and calibrated for a specific type of gas in embodiments. The MFC 406 of the gas stick assembly 400 may be connected to a computing device, processing device or additional controller 430 (e.g., a controller for a processing device, for a tool cluster, etc.). The MFC 406 may generate pressure measurements and send the pressure measurements to the controller 430.

Controller 430 may process the data from the MFC 406 to perform a leak check of the gas stick assembly 400. In embodiments, controller 430 may additionally be connected to one or more valves (e.g., valve 401, valve 402, valve 405 and/or valve 407) of the gas stick assembly 400. All such connections between the controller 430 and one more components of the gas stick assembly 400 may be wired connections or wireless connections (e.g., connections via Wi-Fi, Bluetooth, Zigbee, or another wireless protocol). Through such connections, the controller 430 can cause one or more operations to be performed on the gas stick assembly 400 to effectuate a leak test as set forth in embodiments herein. Accordingly, the controller 430 can measure and monitor the pressure of the mass flow controller 406, either in a pressurized or vacuum system.

In an alternative embodiment, a pressure gauge (not pictured) may be included in the gas stick assembly 400. The pressure gauge may be included in addition to or instead of the MFC 406 within the gas stick assembly. If a pressure gauge is included in the gas stick assembly, it may be included downstream of the regulator 403 and upstream of filter 404. Further, if a pressure gauge is included, then the MFC may not include an internal pressure sensor. In some embodiments, the pressure gauge may be connected to a computing device, processing device or additional controller 430 (e.g., a controller for a processing device, for a tool cluster, etc.). The pressure gauge may generate pressure measurements and send the pressure measurements to the controller 430 as described in relation to the MFC 406. The pressure gauge and pressure sensor of the MFC may be in a flow path of the gas in the gas stick assembly 400.

Embodiments are discussed herein with reference to an MFC that includes an internal pressure sensor. It should be understood that embodiments discussed with reference to use of an MFC to measure pressure within a gas stick assembly may instead use other pressure sensors that are not part of an MFC.

In some embodiments, the controller 430 includes a central processing unit (CPU), microcontroller, a programmable logic controller (PLC), a system on a chip (SoC), a server computer, or other suitable type of computing device. The controller 430 may be configured to execute programming instructions related to one or more physical models as described herein.

FIG. 5 is a block diagram illustrating various components of a mass flow controller (MFC) 500, according to one embodiment. The MFC 500 may be any type of MFC, such as a temperature-based MFC or a pressure-based MFC, both of which regulate mass flow by utilizing different measurement principles. A temperature-based MFC can operate by directing a portion of the gas flow through a thermal flow sensor, where resistive heating elements and temperature sensors detect temperature differences between upstream and downstream positions. This temperature differential can used to calculate the mass flow rate, with a control system adjusting flow as needed. In contrast, a pressure-based MFC can determine flow rate by measuring the pressure drop across a flow restriction element using pressure sensors. The system calculates mass flow based on known gas properties and dynamically adjusts the flow rate to maintain a desired setpoint.

The MFC 500 includes a flow rate control valve 502, which regulates the actual flow of gas (or fluid) through the gas stick assembly based on feedback from flow rate measurements. The flow rate control valve 502 may be a solenoid-based or piezoelectric valve, depending on the application and required response characteristics. In general, the flow rate control valve 502 may be adjusted by an actuator that is often driven by an electrical signal from a processor, such as a CPU 504 or a PID controller 508b. The actuator modulates the opening of the flow rate control valve 502, which can involve changing the position of internal components of the flow rate control valve 502, such as a plug or diaphragm, which alters the size of an aperture through which the gas or fluid flows. As the position of the flow rate control valve 502 is incrementally opened or closed, the flow rate and pressure of the fluid outputted by the gas stick assembly are correspondingly increased or decreased.

The CPU 504 may be provided within the MFC 500 to process and/or output sensor data, execute control algorithms, and adjust system parameters to maintain the desired mass flow rate. The CPU 504 can receive input from one or more flow rate sensors 506, which may include temperature sensor(s) 506a(i.e., for thermal-based flow measurement if the MFC 500 is a thermal-based MFC) and/or pressure sensor(s) 506b (i.e., for pressure-based flow measurement if the MFC 500 is a pressure-based MFC). These sensors provide real-time data on gas flow conditions and allow the CPU 504 to compute the necessary adjustments. The CPU 504 may also receive an input corresponding to a current position (or aperture size) of the flow rate control valve 502.

Additionally, the MFC 500 can include other hardware 508, which may encompass various configurable components that influence flow regulation and response characteristics. For example, a manifold volume 508a parameter may define the internal volume of the MFC’s flow path and may be designed to optimize response time or gas mixing characteristics. Furthermore, the MFC 500 may include a proportional-integral-derivative (PID) controller 508b, which is responsible for dynamically adjusting the control valve 502 based on proportional, integral, and derivative feedback from the flow rate sensor(s) 506. The PID controller 508b enables stable and accurate flow control by compensating for fluctuations in pressure, temperature, or downstream demand. The PID controller 508b may have adjustable parameters, such as proportional gain, integral gain, or derivative gain.

In at least one embodiment, the MFC 500 may output one or more parameter outputs 510 to an external processing device.

FIG. 6 is a flowchart illustrating a method 600 of determining the health of an MFC, according to one embodiment. The method 600 may be performed by processing logic that may comprise hardware (e.g., circuitry, dedicated logic, programmable logic, microcode, etc.), software (e.g., instructions run on a processing device to perform hardware simulation), firmware, or a combination thereof. In some embodiments, the processing logic may include one or more processing devices, such as a controller, that are configured to receive parameter information from different components of a substrate processing system 602. In some embodiments, the method 600 may be at least partially performed by the system controller 128 of FIG. 1 and/or the controller 430 of FIG. 4A and FIG. 4B. The method 600 may be performed other devices described herein.

As stated above, the method 600 may receive parameters from different components of the substrate processing system 602. The substrate processing system 602 may include an MFC, such as the MFC 500 described with respect to FIG. 5, or MFC 406 described with respect to FIG. 4A and FIG. 4B. The substrate processing system 602 may also include non-MFC components, such as the manufacturing chamber 200 described with respect to FIG. 2 and its corresponding components. The substrate processing system 602 may generate one or more MFC parameters 604 and one or more non-MFC parameters 606. The MFC parameters 604 can include any parameters outputted by the MFC, such as a temperature parameter, a pressure parameter, a current position of a control valve of the MFC, settings or parameters of a PID controller, a manifold volume, and the like. The non-MFC parameters 606 can include any parameters corresponding to components of the substrate processing system 602 that do not originate from the MFC. For example, the non-MFC parameters 606 can include a forward power, a reflected power, or a temperature corresponding to an RF generator parameters (e.g., forward power, reflected power, temperature) as described herein, RF probe parameters (e.g., voltage, current, or phase) as described herein, matcher parameters (e.g., series/shunt, cap position, cap current) as described herein, pressure control parameters (e.g., TGV position, gauge readings, O-ring valve condition) as described herein, temperature control parameters (e.g., chiller, inert gas cooling, manufacturing chamber temperature) as described herein, chuck parameters (e.g., voltage bias, current bias, focus ring bias, inert gas pressure, inert gas flow/leak rate, chuck temperature) as described herein, and the like. In at least one embodiment, the non-MFC parameters 606 may also include metrology data, such as measured substrate film thickness and/or film uniformity.

The method 600 may input the flow controller (e.g., MFC) parameters 604 into a physical model 608 of the flow controller. According to embodiments, this physical model 608 is a mathematical or computational representation that captures the underlying behavior, mechanics, and dynamics of the MFC. According to embodiments, the physical model 608 may be a computational fluid dynamics model, a finite element analysis model, a lumped parameter model, a bond graph model, a network flow model, or the like. The physical model 608 may be generated based on historical MFC parameters collected over a range of operating conditions. When the MFC parameters 604 are fed into the physical model 608, the physical model 608 may be capable of predicting how the MFC should perform under those specific conditions. By comparing these predicted outputs to the actual MFC parameters 604, deviations can be detected that may indicate poor MFC health. For example, these deviations may correspond to sensor drift, clogging in the flow path, wear on internal components, or the like. In at least one embodiment, the method 600 may generate a first MFC health index 612 based on the different between MFC parameters predicted by the physical model 608 and the actual MFC parameters 604.

The method 600 may input the non-MFC parameters 606 into a statistical model 610. According to embodiments, the statistical model 610 is configured to model non-MFC parameters of a substrate processing system 602 that has a healthy MFC. The statistical model 610 may include, or be configured to utilize, any of a variety of computational techniques suitable for analyzing system parameters. For example, the statistical model 610 may employ multivariate analysis methods such as principal component analysis (PCA) or multiple linear regression, which facilitate the examination of relationships among multiple variables. Alternatively, the statistical model 610 may leverage machine learning or artificial intelligence (AI) approaches, including neural networks, decision trees, random forests, or deep learning architectures (e.g., convolutional neural networks or recurrent neural networks), that are capable of identifying and learning complex, non-linear patterns in data. Each such approach may be selected based on the system’s data characteristics and the desired predictive or diagnostic objectives, without departing from the scope of the present disclosure. In any event, the statistical model 610 may be generated using historical non-MFC parameters collected over a range of operating conditions. By doing so, the statistical model 610 may be capable of predicting what non-MFC parameters 606 should look like if the substrate processing system 602 has a healthy MFC. Output(s) of the statistical model 610 may be compared to the actual non-MFC parameters 606 to identify any significant deviations, similar to the comparison performed between output(s) of the physical model 608 and the MFC parameters 604. The method 600 may generate a second MFC health index 614 by comparing the output(s) of the statistical model 610 to the non-MFC parameters 606. In at least one embodiment, the statistical model 610 may also consider one or more of the MFC parameters 604.

In at least one embodiment, the first MFC health index 612 and second MFC health index 614 may be used individually to evaluate the health of the MFC of the substrate processing system 602. For example, the first MFC health index 612 may be compared to one or more first thresholds (e.g., a warning threshold and a fault threshold), and the second MFC health index 614 may be compared to one or more second thresholds. These first and second thresholds may be calibrated such that satisfying these respective thresholds indicates that the MFC of the substrate processing system 602 is in poor health, and that one or more settings or parameters of the MFC should be adjusted or calibrated.

In some embodiments, the method 600 may generate a combined MFC health index 616 using the first MFC health index 612 and second MFC health index 614. This combined MFC health index 616 may be any suitable combination or comparison of the first MFC health index 612 and second MFC health index 614. The combined MFC health index 616 may be compared to one or more third thresholds (e.g., a warning threshold and a fault threshold) that are calibrated such that satisfying a third threshold indicates that the MFC of the substrate processing system 602 is in poor health, and that one or more settings or parameters of the MFC should be adjusted or calibrated.

FIG. 7A and FIG. 7B illustrate exemplary graphs 700 of different measured non-MFC parameters of a substrate processing system over time. At a first time T1, parameters of an MFC of the substrate processing system shift outside of normal operation ranges (i.e., is in poor health). This shift in MFC parameters results in a different thickness of film deposition or etch during a film deposition or etch process of the substrate processing system, as illustrated in exemplary graph 702. However, in at least some cases, this shift in MFC parameters may not be captured by a reported flow rate of the MFC. For example, the reported flow rate may remain relatively constant before and after the first time T1.

However, non-MFC parameters may indicate the shift in MFC parameters. For example, TGV percent (graph 702a), foreline pressure (graph 704a), RF probe voltage (graph 706a), DC bias (graph 708a), and other non-MFC parameters may each show significant shifts corresponding to the first time T1. Similarly, upon the MFC parameters shifting back to normal operation ranges at a second time T2, These same non-MFC parameters may return to measured values as observed before the first time T1 (as illustrated in graphs 702b, 704b, 706b, 708b).

FIG. 8 illustrates a model training workflow 805 and a model application workflow 817 for generating a statistical model corresponding to non-MFC parameters, according to one embodiment. Model training workflow 805 and model application workflow 817 may be performed by processing logic executed by a processor of a computing device. One or more of these workflows 805, 817 may be implemented, for example, by one or more machine learning modules implemented on a processing device and/or other software and/or firmware executing on a processing device.

The model training workflow 805 is to train one or more machine learning models (e.g., deep learning models) to predict or otherwise determine a difference in non-MFC parameters between normal operation of an MFC and deviant operation of the MFC. One or more of the machine learning models may receive current non-MFC parameters as described herein as an input.

Various machine learning outputs are described herein. Particular numbers and arrangements of machine learning models are described and shown. However, it should be understood that the number and type of machine learning models that are used and the arrangement of such machine learning models can be modified to achieve the same or similar end results. Accordingly, the arrangements of machine learning models that are described and shown are merely examples and should not be construed as limiting.

In embodiments, one or more machine learning models are trained to perform one or more tasks. Each task may be predicting or otherwise determining a difference between a non-MFC parameter during normal operation of the MFC and the non-MFC parameter deviant operation of the MFC. Each task may correspond to a different non-MFC parameter. In one embodiment, each task may be performed by a separate machine learning model. Alternatively, a single machine learning model may perform each of the tasks or a subset of the tasks. Additionally, or alternatively, different machine learning models may be trained to perform different combinations of the tasks. In an example, one or a few machine learning models may be trained, where the trained machine learning (ML) model is a single shared neural network that has multiple shared layers and multiple higher level distinct output layers, where each of the output layers outputs a different prediction, classification, identification, etc.

One type of machine learning model that may be used to perform some or all of the above tasks is an artificial neural network, such as a deep neural network. Artificial neural networks generally include a feature representation component with a classifier or regression layers that map features to a desired output space. A convolutional neural network (CNN), for example, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g. classification outputs). Deep learning is a class of machine learning algorithms that use a cascade of multiple layers of nonlinear processing units for feature extraction and transformation. Each successive layer uses the output from the previous layer as input. Deep neural networks may learn in a supervised (e.g., classification) and/or unsupervised (e.g., pattern analysis) manner. Deep neural networks include a hierarchy of layers, where the different layers learn different levels of representations that correspond to different levels of abstraction. In deep learning, each level learns to transform its input data into a slightly more abstract and composite representation. Notably, a deep learning process can learn which features to optimally place in which level on its own. The “deep” in “deep learning” refers to the number of layers through which the data is transformed. More precisely, deep learning systems have a substantial credit assignment path (CAP) depth. The CAP is the chain of transformations from input to output. CAPs describe potentially causal connections between input and output. For a feedforward neural network, the depth of the CAPs may be that of the network and may be the number of hidden layers plus one. For recurrent neural networks, in which a signal may propagate through a layer more than once, the CAP depth is potentially unlimited.

Training of a neural network may be achieved in a supervised learning manner, which involves feeding a training dataset consisting of labeled inputs through the network, observing its outputs, defining an error (by measuring the difference between the outputs and the label values), and using techniques such as deep gradient descent and backpropagation to tune the weights of the network across all its layers and nodes such that the error is minimized. In many applications, repeating this process across the many labeled inputs in the training dataset yields a network that can produce correct output when presented with inputs that are different than the ones present in the training dataset.

For model training workflow 805, a training dataset containing hundreds, thousands, tens of thousands, hundreds of thousands or more historical non-MFC parameter data can be used to form a training dataset. Data may include, for example, first historical non-MFC parameter data corresponding to normal MFC operating conditions and second historical non-MFC parameter data corresponding to deviant MFC operating conditions. This data may be processed to generate one or more training datasets 836 for the training of one or more machine learning models.

To effectuate training, processing logic inputs the training dataset(s) 836 into one or more untrained machine learning models. Prior to inputting a first input into a machine learning model, the machine learning model may be initialized. Processing logic trains the untrained machine learning model(s) based on the training dataset(s) to generate one or more trained machine learning models that perform various operations as set forth above. Training may be performed by inputting the historical non-MFC data into the machine learning.

The machine learning model processes the input to generate an output. An artificial neural network includes an input layer that consists of values in a data point. The next layer is called a hidden layer, and nodes at the hidden layer each receive one or more of the input values. Each node contains parameters (e.g., weights) to apply to the input values. Each node therefore essentially inputs the input values into a multivariate function (e.g., a non-linear mathematical transformation) to produce an output value. A next layer may be another hidden layer or an output layer. In either case, the nodes at the next layer receive the output values from the nodes at the previous layer, and each node applies weights to those values and then generates its own output value. This may be performed at each layer. A final layer is the output layer, where there is one node for each class, prediction and/or output that the machine learning model can produce.

Accordingly, the output may include one or more predictions or inferences. For example, an output prediction or inference may include one or more values indicating a difference between the inputted non-MFC parameters and expected non-MFC parameters. The output prediction or inference may be an MFC health index, as described above with respect to the second MFC health index 614 of FIG. 6. In the training phase, the output prediction or inference may be compared to an expected prediction or inference, and based on an error (i.e., difference) between the outputted prediction or inference and expected prediction or inference, may adjust weights of one or more nodes in the machine learning model based on the error. An error term or delta may be determined for each node in the artificial neural network. Based on this error, the artificial neural network adjusts one or more of its parameters for one or more of its nodes (the weights for one or more inputs of a node). Parameters may be updated in a back propagation manner, such that nodes at a highest layer are updated first, followed by nodes at a next layer, and so on. An artificial neural network contains multiple layers of “neurons”, where each layer receives as input values from neurons at a previous layer. The parameters for each neuron include weights associated with the values that are received from each of the neurons at a previous layer. Accordingly, adjusting the parameters may include adjusting the weights assigned to each of the inputs for one or more neurons at one or more layers in the artificial neural network.

Once the model parameters have been optimized, model validation may be performed to determine whether the model has improved and to determine a current accuracy of the deep learning model. After one or more rounds of training, processing logic may determine whether a stopping criterion has been met. A stopping criterion may be a target level of accuracy, a target number of processed images from the training dataset, a target amount of change to parameters over one or more previous data points, a combination thereof and/or other criteria. In one embodiment, the stopping criteria is met when at least a minimum number of data points have been processed and at least a threshold accuracy is achieved. The threshold accuracy may be, for example, 70%, 80% or 90% accuracy. In one embodiment, the stopping criterion is met if accuracy of the machine learning model has stopped improving. If the stopping criterion has not been met, further training is performed. If the stopping criterion has been met, training may be complete. Once the machine learning model is trained, a reserved portion of the training dataset may be used to test the model.

As an example, a machine learning model (e.g., trained ML model 882) is trained to determine changes in at least one non-MFC parameter over time. A similar process may be performed to train machine learning models to determine changes in at least one other non-MFC parameters over time. Once one or more trained ML models 882 are generated, they may be stored in model storage 845.

According to one embodiment, input data 862 may include current non-MFC parameters, such as those described herein. The input data 862 may be input into the trained ML models 882. The trained ML models 882 may output trained ML model output(s) 884 that indicate whether or not the MFC of the substrate processing system is operating within normal operating conditions. The trained ML model output(s) 884 may be used in downstream processing to determine whether or not the MFC of the substrate processing system is operating within normal operating conditions, and whether or not to perform any corrective actions corresponding to the MFC.

FIG. 9 is a flowchart illustrating a method 900 of determining the health of an MFC, according to one embodiment. The method 900 may be performed by processing logic that may comprise hardware (e.g., circuitry, dedicated logic, programmable logic, microcode, etc.), software (e.g., instructions run on a processing device to perform hardware simulation), firmware, or a combination thereof. In some embodiments, the processing logic may include one or more processing devices, such as a controller, that are configured to receive parameter information from different components of a substrate processing system 602. In some embodiments, the method 900 may be at least partially performed by the system controller 128 of FIG. 1 and/or the controller 430 of FIG. 4A and FIG. 4B. The method 900 may be performed other devices described herein.

At block 902, the processing logic may receive one or more MFC parameters and one or more non-MFC parameters. The MFC parameters 604 can include any parameters outputted by the MFC, such as a temperature parameter, a pressure parameter, a current position of a control valve of the MFC, settings or parameters of a PID controller, a manifold volume, and the like. The non-MFC parameters 606 can include any parameters corresponding to components of the substrate processing system 602 that do not originate from the MFC. For example, the non-MFC parameters 606 can include a forward power, a reflected power, or a temperature corresponding to an RF generator parameters (e.g., forward power, reflected power, temperature) as described herein, RF probe parameters (e.g., voltage, current, or phase) as described herein, matcher parameters (e.g., series/shunt, cap position, cap current) as described herein, pressure control parameters (e.g., TGV position, gauge readings, throttle valve condition) as described herein, temperature control parameters (e.g., chiller, inert gas cooling, manufacturing chamber temperature) as described herein, chuck parameters (e.g., voltage bias, current bias, focus ring bias, inert gas pressure, inert gas flow/leak rate, chuck temperature) as described herein, and the like.

At block 904, the processing logic may input the MFC parameters into a physical model. This physical model may be as described herein. By inputting the MFC parameters into the physical model, the processing logic may be capable of generating a first MFC health index at block 906. This first MFC health index may be indicative of the health of the MFC of the substrate processing system. In one embodiment, the physical model may generate the first MFC health index. In another embodiment, the first MFC health index may be generated based on one or more outputs of the physical model, such as an expected flow rate or the like.

At block 906, the processing logic may optionally compare the first MFC health index to one or more first thresholds. These one or more first thresholds may include a warning threshold and a fault threshold. According to embodiments, if the first MFC health index satisfies one or more of the one or more first thresholds, at least one corrective action may be performed at block 920.

At block 910, the processing logic may input the non-MFC parameters into a statistical model. This statistical model may be as described herein. By inputting the non-MFC parameters into the statistical model, the processing logic may be capable of generating a second MFC health index at block 912. Similar to the first MFC health index, the second health index may be indicative of the health of the MFC of the substrate processing system. In one embodiment, the statistical model may generate the second MFC health index. In another embodiment, the second MFC health index may be generated based on one or more outputs of the statistical model.

At block 914, the processing logic may optionally compare the second MFC health index to one or more second thresholds. These one or more second thresholds may include a warning threshold and a fault threshold. According to embodiments, if the second MFC health index satisfies one or more of the one or more second thresholds, at least one corrective action may be performed at block 920.

At block 916, the processing logic may generate a combined MFC health index using the first and second MFC health indices. In one embodiment, the combined MFC health index may be an aggregation of the first and second MFC health indices. In another embodiment, the combined MFC health index may be a ratio between the first and second MFC health indices. The first and second MFC health indices may be compared or combined in any suitable manner that allows the processing logic to gauge the health of the MFC of the substrate processing system.

At block 918, the processing logic may compare the combined MFC health index to one or more third thresholds. These one or more third thresholds may include a warning threshold and a fault threshold. According to embodiments, if the combined MFC health index satisfies one or more of the one or more third thresholds, at least one corrective action may be performed at block 920.

At block 920, if at least one of the respective one or more first thresholds, the one or more second thresholds, or the one or more third thresholds are satisfied, a corrective action may be performed. This corrective action may include alerting users of the substrate processing system that the health of the MFC is suspect (e.g., if a warning threshold is satisfied), or that the MFC requires maintenance (e.g., if a fault threshold is satisfied). In some embodiments, the corrective action may include adjusting a position of a control valve or another parameter of the MFC. Here, the one or more of the second MFC health index and the combined MFC health index may indicate whether the control valve is too open (i.e., deposited film on substrate is too thick) or too closed (i.e., deposited film on substrate is too thin), and may be used to adjust the control valve of the MFC until film deposited on the substrate is within a target thickness range.

FIG. 10 depicts a block diagram of an example computing device capable of process drift and film thickness determination, operating in accordance with one or more aspects of the disclosure. In various illustrative examples, various components of the computing device 1000 may represent various components of a computing device, controller, and/or control panel (e.g., analogous elements described in association with FIG. 1 to FIG. 5).

Example computing device 1000 may be connected to other computer devices in a local area network (LAN), an intranet, an extranet, and/or the Internet. Computing device 1000 may operate in the capacity of a server in a client-server network environment. Computing device 1000 may be a personal computer (PC), a set-top box (STB), a server, a network router, switch or bridge, or any device capable of executing a set of instructions (sequential or otherwise) that specify actions to be taken by that device. Further, while only a single example computing device is illustrated, the term “computer” shall also be taken to include any collection of computers that individually or jointly execute a set (or multiple sets) of instructions to perform any one or more of the methods discussed herein.

Example computing device 1000 may include a processing device 1002 (also referred to as a processor or CPU), a main memory 1004 (e.g., read-only memory (ROM), flash memory, dynamic random access memory (DRAM) such as synchronous DRAM (SDRAM), etc.), a static memory 1006 (e.g., flash memory, static random access memory (SRAM), etc.), and a secondary memory (e.g., a data storage device 1018), which may communicate with each other via a bus 1030.

Processing device 1002 represents one or more general-purpose processing devices such as a microprocessor, central processing unit, or the like. More particularly, processing device 1002 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 1002 may also be one or more special-purpose processing devices such as an application specific integrated circuit (ASIC), a field programmable gate array (FPGA), a digital signal processor (DSP), network processor, or the like. In accordance with one or more aspects of the disclosure, processing device 1002 may be configured to execute instructions implementing methods 600, 900 illustrated in FIG. 6 and FIG. 9, respectively.

Example computing device 1000 may further comprise a network interface device 1008, which may be communicatively coupled to a network 1020. Example computing device 1000 may further comprise a video display 1010 (e.g., a liquid crystal display (LCD), a touch screen, or a cathode ray tube (CRT)), an alphanumeric input device 1012 (e.g., a keyboard), a cursor control device 1014 (e.g., a mouse), and an acoustic signal generation device 1016 (e.g., a speaker).

Data storage device 1018 may include a machine-readable storage medium (or, more specifically, a non-transitory machine-readable storage medium) 1028 on which is stored one or more sets of executable instructions 1022. In accordance with one or more aspects of the disclosure, executable instructions 1022 may comprise executable instructions associated with executing methods 600, 900 illustrated in FIG. 6 and FIG. 9, respectively.

Executable instructions 1022 may also reside, completely or at least partially, within main memory 1004 and/or within processing device 1002 during execution thereof by example computing device 1000, main memory 1004 and processing device 1002 also constituting computer-readable storage media. Executable instructions 1022 may further be transmitted or received over a network via network interface device 1008.

While the computer-readable storage medium 928 is shown in FIG. 10 as a single medium, the term “computer-readable storage medium” should be taken to include a single medium or multiple media (e.g., a centralized or distributed database, and/or associated caches and servers) that store the one or more sets of operating instructions. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “identifying,” “determining,” “storing,” “adjusting,” “causing,” “receiving,” “comparing,” “measuring,” “correcting,” “applying,” “using,” “obtaining,” “replacing,” “performing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the disclosure also relate to an apparatus for performing the methods described herein. This apparatus may be specially constructed for the target purposes, or it may be a general purpose computer system selectively programmed by a computer program stored in the computer system. Such a computer program may be stored in a computer readable storage medium, such as, but not limited to, any type of disk including optical disks, compact disc read only memory (CD-ROMs), and magnetic-optical disks, read-only memories (ROMs), random access memories (RAMs), erasable programmable read-only memory (EPROMs), electrically erasable programmable read-only memory (EEPROMs), magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general purpose systems may be used with programs in accordance with the teachings herein, or it may prove convenient to construct a more specialized apparatus to perform the method steps. The structure for a variety of these systems will appear as set forth in the description below. In addition, the scope of the disclosure is not limited to any particular programming language. It will be appreciated that a variety of programming languages may be used to implement the teachings of the disclosure.

The preceding description sets forth numerous specific details such as examples of specific systems, components, methods, and so forth, in order to provide a good understanding of several embodiments of the disclosure. It will be apparent to one skilled in the art, however, that at least some embodiments of the disclosure may be practiced without these specific details. In other instances, well-known components or methods are not described in detail or are presented in simple block diagram format in order to avoid unnecessarily obscuring the disclosure. Thus, the specific details set forth are merely exemplary. Particular implementations may vary from these exemplary details and still be contemplated to be within the scope of the disclosure.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.” When the term “about” or “approximately” is used herein, this is intended to mean that the nominal value presented is precise within ±10%.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

In embodiments, processing logic determines whether there is a leak by comparing at least a second pressure generated later in the second time period (e.g., at an end of the second time period) to a first pressure generated earlier in the second time period (e.g., at a beginning of the second time period). Based on the comparison, processing logic determines whether there is a difference between the two (or more) pressure measurements (e.g., whether the second pressure is lower than the first pressure by at least a threshold amount). If there is a difference detected, then processing logic determines whether at least a portion of the gas stick assembly has a leak based on whether the detected pressure difference exceeds a pressure difference threshold. If the pressure difference exceeds the pressure difference threshold, then a leak is detected. If there is no pressure difference, or the pressure difference does not exceed the pressure difference threshold, then no leak is detected. In embodiments, the pressure difference threshold is about 5 psi to about 15 psi. Other pressure difference thresholds may also be used.

In another embodiment of the present disclosure, a system is provided. The system may include a memory and a processing device. The processing device may operatively be coupled to the memory. The processing device is configured to cause a valve of the gas stick assembly that is either downstream or upstream of a mass flow controller of the gas stick assembly according to the present disclosure to close. The processing device is also configured to cause one or more additional valves of the gas stick assembly system to remain open for a time period until the gas stick assembly reaches a target pressure. The processing device may also cause a second valve of the one or more additional valves to close once the gas stick assembly reaches the target pressure, wherein at least a portion of the gas stick between the first valve and the second valve has the target pressure after closing the second valve. The processing device may then receive pressure data for a pressure within at least the portion of the gas stick assembly from the MFC over a second time period; and analyze the pressure data to determine whether at least the portion of the gas stick assembly has a leak. In some embodiments, the target pressure may be about 10 psia to about 50 psia, or about 10 psia, about 15 psia, about 20 psia, about 25 psia, about 30 psia, about 35 psia, about 40 psia, about 45 psia, or about 50 psia, or any value therein.

The preceding description sets forth numerous specific details such as examples of specific systems, components, methods, and so forth, in order to provide a good understanding of several embodiments of the present invention. It will be apparent to one skilled in the art, however, that at least some embodiments of the present invention may be practiced without these specific details. In other instances, well-known components or methods are not described in detail or are presented in simple block diagram format in order to avoid unnecessarily obscuring the present invention. Thus, the specific details set forth are merely exemplary. Particular implementations may vary from these exemplary details and still be contemplated to be within the scope of the present invention.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.” When the term “about” or “approximately” is used herein, this is intended to mean that the nominal value presented is precise within ±10%.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner. In one embodiment, multiple metal bonding operations are performed as a single step.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

1. A system comprising:
one or more processing chambers;
one or more first sensors that each measure at least one of a first group of parameters of a substrate manufacturing process implemented using the one or more processing chambers;
a flow controller that controls a flow of one or more gases into the processing chamber;
one or more second sensors that each measure at least one of a second group of parameters of the flow controller during the substrate manufacturing process; and
one or more processors to:
generate, using a first model, a first health index of the flow controller based on the first group of parameters;
generate, using a second model, a second health index of the flow controller based on the second group of parameters; and
based on at least one of the first health index or the second health index, perform a corrective action with respect to the flow controller.

2. The system of claim 1, wherein the one or more processors are further to:
generate a combined index by cross-comparing the first health index and the second health index, wherein the corrective action is performed responsive to a determination that the combined index satisfies a threshold.

3. The system of claim 1, wherein the first group of parameters and second the second group of parameters are mutually exclusive.

4. The system of claim 1, wherein the first group of parameters comprises at least two of a radio frequency (RF) probe voltage, a throttle gate valve (TGV) position, a foreline pressure, an optical sensor measurement, or a direct current (DC) bias voltage.

5. The system of claim 1, wherein the second group of parameters comprises at least two of a temperature parameter, a pressure parameter, a control valve position, or a flow rate.

6. The system of claim 1, wherein the corrective action comprises adjusting a position of a control valve of the flow controller.

7. The system of claim 1, wherein the first model comprises at least one of a machine learning model or a multivariate regression model, and wherein the second model comprises a physical model.

8. The system of claim 1, wherein the flow controller is a thermal-based mass flow controller (MFC) or a pressure-based MFC.

9. A device comprising:
one or more processors to:
receive a first group of parameters corresponding to a substrate manufacturing process;
generate, using a statistical model, a first health index of a flow controller based on the first group of parameters;
receive a second group of parameters corresponding to the flow controller used during the substrate manufacturing process;
generate, using a physical model, a second health index of the flow controller based on the second group of parameters; and
based on at least one of the first and second health indices, perform a corrective action with respect to the flow controller.

10. The device of claim 9, wherein the one or more processors are further to:
generate a combined index by cross-comparing the first health index and second health index, wherein the corrective action is performed responsive to a determination that the combined index satisfies a threshold.

11. The device of claim 9, wherein the first group of parameters and the second group of parameters are mutually exclusive.

12. The device of claim 9, wherein the first group of parameters comprises at least two of a radio frequency (RF) probe voltage, a throttle gate valve (TGV) position, a foreline pressure, or a direct current (DC) bias voltage.

13. The device of claim 9, wherein the second group of parameters comprises at least two of a temperature parameter, a pressure parameter, a control valve position, or a flow rate.

14. The device of claim 9, wherein the corrective action comprises adjusting a position of a control valve of the flow controller.

15. The device of claim 9, wherein the statistical model comprises at least one of a machine learning model or a multivariate regression model.

16. The device of claim 9, wherein the flow controller is a thermal-based mass flow controller (MFC) or a pressure-based MFC.

17. A method comprising:
receiving a first group of parameters corresponding to a substrate manufacturing process;
generating, using a statistical model, a first health index of a flow controller based on the first group of parameters;
receiving a second group of parameters corresponding to the flow controller used during the substrate manufacturing process;
generating, using a physical model, a second health index of the flow controller based on the second group of parameters; and
based on at least one of the first and second health indices, perform a corrective action with respect to the flow controller.

18. The method of claim 17, further comprising:
generating a combined index by cross-comparing the first health index and the second health index, wherein the corrective action is performed responsive to a determination that the combined index satisfies a threshold.

19. The method of claim 17, wherein the first group of parameters and the second group of parameters are mutually exclusive.

20. The method of claim 17, wherein the statistical model comprises at least one of a machine learning model or a multivariate regression model.
